(19) United States
(12) Patent Application Publication
(10) Pub. No.: US 2005/0137313 A1
(43) Pub. Date: Jun. 23, 2005

(54) Dry powdered colorant mixing and dispensing process

(76) Inventors: Sui Kay Wong, North Point (HK); Ki Tam, Kwai Chung, N.T. (HK)

Correspondence Address: Kevin J. McGough, 714 Colorado Avenue, Bridgeport, CT, 06605, US

(21) Appl. No.: 11/010,960

(22) Filed: Dec. 13, 2004

Related U.S. Application Data
(60) Provisional application No. 60/532,143, filed on Dec. 23, 2003.

(51) Int. Cl. C08K 5/01

(52) U.S. Cl. 524/487

(57) ABSTRACT

The invention provides novel Dry Powder Colorant Dispensing Charges (“DPCDC's”) comprising either Powdered Colored Carrier (“PCC”) systems or micro-size color concentrate mixture (“MCCM”) systems useful in making colored thermoplastic articles through a variety of techniques including injection molding. Novel processes for making colored thermoplastic articles by using DPCDC's of the invention are also provided.

### FIELD OF THE INVENTION

The invention provides novel Dry Powder Colorant Dispensing Charges (“DPCDC's”) comprising either Powdered Colored Carrier (“PCC”) systems or micro-size color concentrate mixture (“MCCM”) systems useful in making colored thermoplastic articles through a variety of techniques including injection molding. Novel processes for making colored thermoplastic articles by using DPCDC's of the invention are also provided.

### BACKGROUND OF THE INVENTION

During the manufacture of colored thermoplastic articles through processes such as injection molding, colorants may be added to color the entire article, as opposed to just its surface. In order to accomplish this, a dry colorant (comprised, e.g., of organic pigments, inorganic pigments, dyes, or color concentrates) or a liquid colorant are added to the plastic, either as a part of the formulated plastic pellet, as an additive colorant pellet, or as a liquid that is added immediately before or at the time the plastic enters the injection unit.

Pigments used in such a process must first be carefully weighed and mixed, taking into account their inherent properties and their intended performance functions within the host plastic material. Blending of pigment within a mixer achieves particle reduction through mechanical or chemical processes and moisture is removed. Typically, formulated colorant is blended at least twice with plastic pellets. Thereafter, the pigmented plastic material undergoes a heat/melt process during which colorant is further distributed and dispersed. As an end result of the process, plastic is molded into the desired dimensional shape.

Pigments and dyes are two main plastic colorants used in making colored thermoplastic articles. Examples of dyes useful as thermoplastic colorants include compositions that are soluble in a thermoplastic and that comprise chromophores of the quinacridone, anthraquinone, perylene, indigo, quinophthalone, indanthrone, isoindolinone, isoindoline, dioxazine, azo, phthalocyanine or diketopyrrolopyrrole series. Such dyes create brighter and richer colors than pigments, can be used to enhance pigment-based colors, and can be used to tint clear plastics. However, limitations of dyes include the fact that they often provide poor UV stability and thermal performance, bleed and plate out in polyolefins or engineered resins, may not respond well in high temperature processing, are not opaque, and are not as varied in color as pigments.

Pigments are organic or inorganic fine particles that can range in size from about 20 microns to about 0.01 microns and that can be dispersed and suspended in a plastic resin or compound. Examples of organic pigments include compositions comprising phthalocyanine, quinacridone, and isoindoline. Inorganic pigments include compositions comprising titanium dioxide, iron oxide, Ultramarine, and certain heavy metals. Pigments can be used to create opacity and translucent effects in plastics, are generally cost-effective, can provide enhanced UV stability, thermal resistance properties and increased dispersion performance, are increasingly environmentally-friendly, and are widely used in black or white applications as well as color applications.

However, limitations of pigments include the fact that they are generally insoluble in, and poorly dispersible in, plastics, may pose environmental problems if comprised of heavy metals, and may prove unstable under certain processing conditions. In order to help the dispersion of pigment throughout the molten plastic, a dispersion agent such as polyethylene wax normally added to the pigment during mixing with the plastic resin. The dispersion agent will melt at a lower temperature and act as a lubricant to help disperse the pigment throughout the plastic during the melting and mixing process in making colored articles.

Dyes and pigments, in turn, are used to create the four major categories of colorants used to make colored thermoplastic articles. These are dry colorants, comprised of a powdered material and usually supplied in pre-measured packages. Dry colorants are economical, easy to formulate, suitable for short runs, have no “minimum order quantity” (“MOQ”), can be used in short and emergency runs, are suitable for use with polyethylene in roto-molding, and are provided by numerous suppliers on a short lead time. However, dry colorants entail bulky handling when pre-mixed with resin And create dust contamination that adversely effects the working environment and processing equipment.

Liquid colorants are comprised of liquid materials comprising pigments or dyes of varying viscosity. Liquid colorants are easy to use, are cost effective for long and continuous runs, are compatible with many plastics, typically show good dispersion, can be changed quickly, and result in minimum material wastage. However, use of liquid colorants entails a long lead time, a limited choice of source, limitations to pre-formulated colorants, continuous run use only, inflexibility insofar as batch production or small volume production is concerned, relatively high cost and inventory value, and MOQ for each color.

Normally, the weight percentage ratio of dry colorant to plastic resin used in thermoplastic molding processes ranges from about 0.1% to about 1% of colorant per unit weight of plastic resin. It is difficult to dispense such small amounts of fine powder dry colorant as a liquid colorant per shot. The normal practice is to mix the dry colorant with plastic resin and small amount of mineral oil to enable the colorant powder to stick onto the resin pellet surface (this is usually referred to as a “pigmentation process”). A pigmentation process creates a large amount of work in terms of material handling and cleaning of mixing barrels, and during the process plastic resins are exposed to air and may absorb moisture and become contaminated. Hopper drying also causes the dry colorant to be blown into the environment.

Injection molding processes in which conventional color concentrate is used, either by pre-mixing with resin pellets or dispension into the mix and melting barrel unit, still suffer from the disadvantages of inflexibility (the color concentrate must be custom made), higher cost, MOQ (which is not good for small batch production), longer lead time, and utility limited to general purpose plastics such as ABS (acrylonitrile butadiene styrene), PVC (polyvinyl chloride), PE (polyethlylene), but not engineered plastics such as nylon and POM (polyoxymethylene). Conventional color concentrates are materials that are dispersed in a resin formulated for use with a single resin family. Conventional color concentrates are available as pellets, beads, cubes, wafers and micro-beads, are dust free, easy flowing, and easy to measure. However, conventional color concentrates take a longer lead time to develop than alternative colorants, are pre-formulated and are suitable for continuous run but not small batch running, are not as flexible as pigments, are available from only a limited source of suppliers, perform better than liquid colorants but not dry colorants, and have a high inventory value and MOQ for each color.

Pre-colored resins are already colored to specification when they arrive to the plastic processor and offer the convenience of a ready-to use material, superior dispersion, and no dust contamination. However, pre-colored resins are relatively inflexible, are available from only a limited number of suppliers, require a long lead time, have large MOQ's for each color, and are not applicable to all plastics in low consumption situations.

U.S. Pat. No. 5,462,709 describes a process for coloring polymethacrylates or polyglutarimides in an extruder that includes admixing molten thermoplastic conveyed directly from the polymerization operation in an extruder mixing zone with a dispersion of at least one pigment, dye, or colorant in a suitable clear carrier, and then conveying the admixed colored thermoplastic into an extrusion zone or injection molding zone.

U.S. Pat. No. 5,919,530 describes a process comprising providing a thermoplastic resin body that is at a first temperature; applying, to at least a portion of the thermoplastic resin body, a thermoplastic coating composition comprising an additive component, the additive component comprising a pigment present in an amount of from about 3% to 8% by weight, based on the weight of the customized thermoplastic resin and a polymeric component, wherein the coating composition has a melt processing range and further wherein the first temperature is above the onset temperature of the melt processing range of the coating composition; and cooling the coated thermoplastic resin to solidify the coating to produce a customized thermoplastic resin.

However, the processes of the aforementioned references do not satisfy the need for an improved process for making colored plastic parts through a variety of techniques including injection molding which has the following characteristics: reduced amounts of material handling, direct feed of natural colored resin into the molding machine, hopper drying of only the resin pellet without pigment, dispensing of the colorant directly to the mix and melt barrel unit as the liquid colorant or color concentrate, flexibility and economy comparable to that offered by existing dry colorant processes, short lead time, no MOQ, and a color variety comparable to that provided by existing dry colorant processes.

### SUMMARY OF THE INVENTION

The invention provides novel Dry Powder Colorant Dispensing Charges (“DPCDC's”) comprising either Powdered Colored Carrier (“PCC”) systems or Micro-size Color Concentrate Mixture (“MCCM”) systems useful in making colored thermoplastic articles through a variety of techniques including injection molding. The invention also provides novel processes for making DPCDC's, as well as novel processes for making colored thermoplastic articles by using DPCDC's of the invention.

In one embodiment, a DPCDC of the invention comprises a PCC system made by either:
(1) mixing a known powder form pigment dispersion agent such as polyethylene wax powder with dry pigment colorants to form a condensed colored plastic wax powder; and mixing and diluting the condensed colored plastic wax powder with a carrier powder formed by grinding a carrier resin to a particle size from about 25 to about 1,000 microns; or
(2) forming a colored plastic wax mixture by mixing or dissolving dry pigment colorants or liquid colorants into a molten plastic wax which acts as a pigment dispersion agent; solidifying the colored plastic wax mixture to form a condensed colored plastic wax; crushing and grinding the condensed colored plastic wax to form a condensed colored plastic wax powder; and mixing and diluting the condensed colored plastic wax powder with a carrier powder formed by grinding a carrier resin to a particle size from about 25 to about 1,000 microns; or
(3) mixing and diluting dry pigment colorants and a carrier powder formed by grinding a carrier resin to a particle size from about 25 to about 1,000 microns.

These PCC systems may be dispensed into a powder dispensing unit (“PDU”) and thereafter fed to a process unit such as a mixing and melting barrel wherein the PCC is mixed and melted with plastic resin to form colored plastic parts.

In another embodiment, a DPCDC of the invention comprises MCCM systems made by mixing at least two basic color micro-sized concentrate powders formed by either:
(1) mixing two or more basic color micro-bead color concentrates; or
(2) grinding basic color concentrate pellets into powder form having a particle size from about 25 to about 1,000 microns, preferably about 80 to about 500 microns, and most preferably about 100 to about 300 microns. MCCM systems of the invention may be used to blend a required color from a basic micro-size color concentrate. This eliminates the need for pre-colored concentrates, thereby reducing production lead time and manufacturing quality control problems and increasing manufacturing flexibility and quality.

MCCM systems of the invention may be dispensed into a PDU and thereafter fed to a process unit such as a mixing and melting barrel wherein the MCCM is mixed and melted with plastic resin to form colored plastic parts.

PCC and MCCM systems and processes of the invention offer numerous advantages over the dry colorant, liquid colorant, and color concentrate techniques previously described.

In order to dispense dry colorants (i.e., powdered form of pigments and dyes), processes of the invention dilute the dry colorants with a carrier powder as described above which helps to increase the volume and weight portion of dry colorant and allows it to be dispensed through a powder dispenser into the mixing and melting barrel unit used in a variety of plastic processing machines (injection molding, blow molding, injection blow molding, extruder etc). A plastic wax (e.g., a polyethylene (“PE”) wax) may serve as a colorant dispersion agent to help to disperse the colorant evenly into the plastic. The carrier powder has particle size that ranges from about 25 to about 1,000 microns, usually about 80 to about 500 microns, and preferably from about 100 to about 300 microns.

MCCM systems of the invention enable the use of basic color micro-bead color concentrates or ground basic color concentrate powders in formulating required colored plastics in MCCM form for accurate dispersion into a processing machine. MCCM systems of the invention may be dispended on a “per shot basis”. Formulation convenience is comparable to that of pigments and dyes.

PCC systems of the invention expand the volumetric characteristic of a colorant and allow the colorant in PCC form to be dispensed into the processing machine as accurately as needed. The carrier powder in the PCC systems also provides sufficient surface area onto which dry pigments can adhere. PCC may be dispended on a “per shot basis”. Formulation convenience is comparable to that of pigments and dyes.

In one embodiment, the invention provides processes for making colored thermoplastic articles comprising mixing and melting a DPCDC of the invention and a plastic resin in a mixing and melting barrel unit, wherein:
(a) the weight ratio of DPCDC to plastic resin ranges from 1% to about 15% of DPCDC per unit weight of plastic resin; and
(b) the carrier powder and plastic resin are comprised of either the same plastic or two or more different plastics.

Processes and systems of the invention: generate less dust compared to traditional color concentrate and pre-colored resin processes; may be used in small and large batch production; are inexpensive; may be used with a wide variety of thermoplastics; minimize color change waste; reduce the amount of material handled in resin colorant mixing; result in minimum environmental contamination; require minimum inventory; and pose no significant manufacturing quality control problems.

These and other aspects of the invention are described further in the following detailed description.

### BRIEF DESCRIPTION OF THE FIGURES

FIGS. 1A to 1E illustrate processes for making DPCDC's in accordance with the invention.

FIG. 2 illustrates the structure of a PDU and illustrates how a PDU is linked to a mix and melt barrel useful in processes of the invention.

FIGS. 3A and 3B illustrate in flow chart format processes for making DPCDC's in accordance with the invention.

### DETAILED DESCRIPTION OF THE INVENTION

As used herein, the following terms have the following respective meanings.

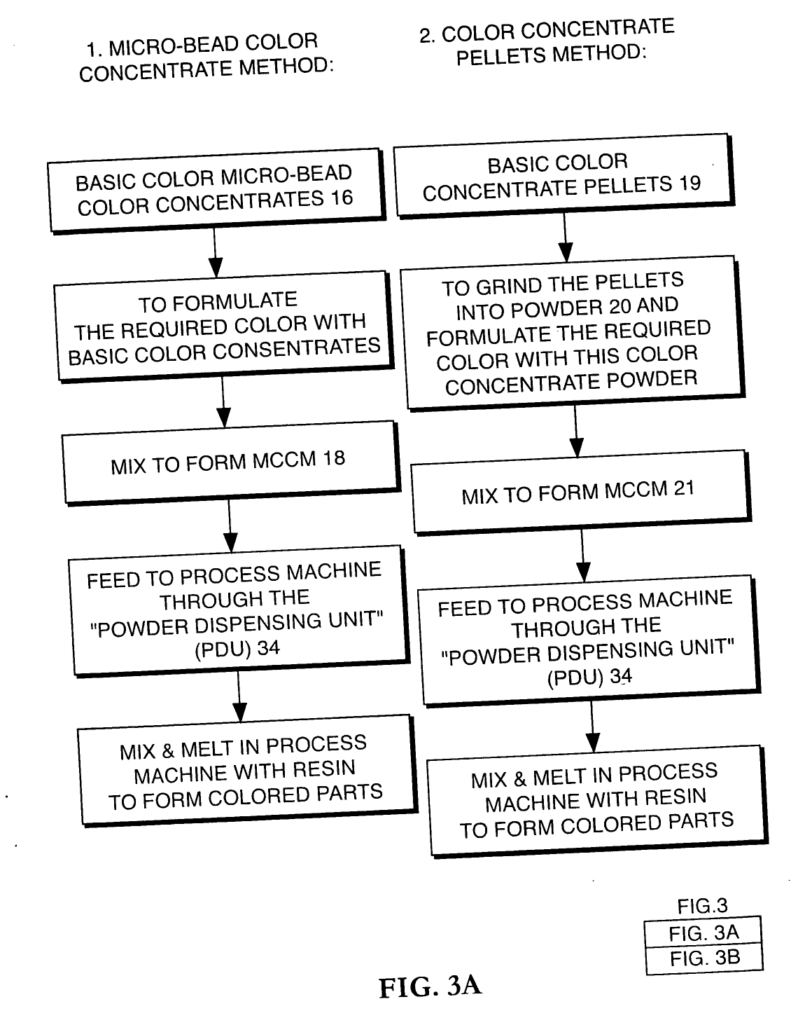

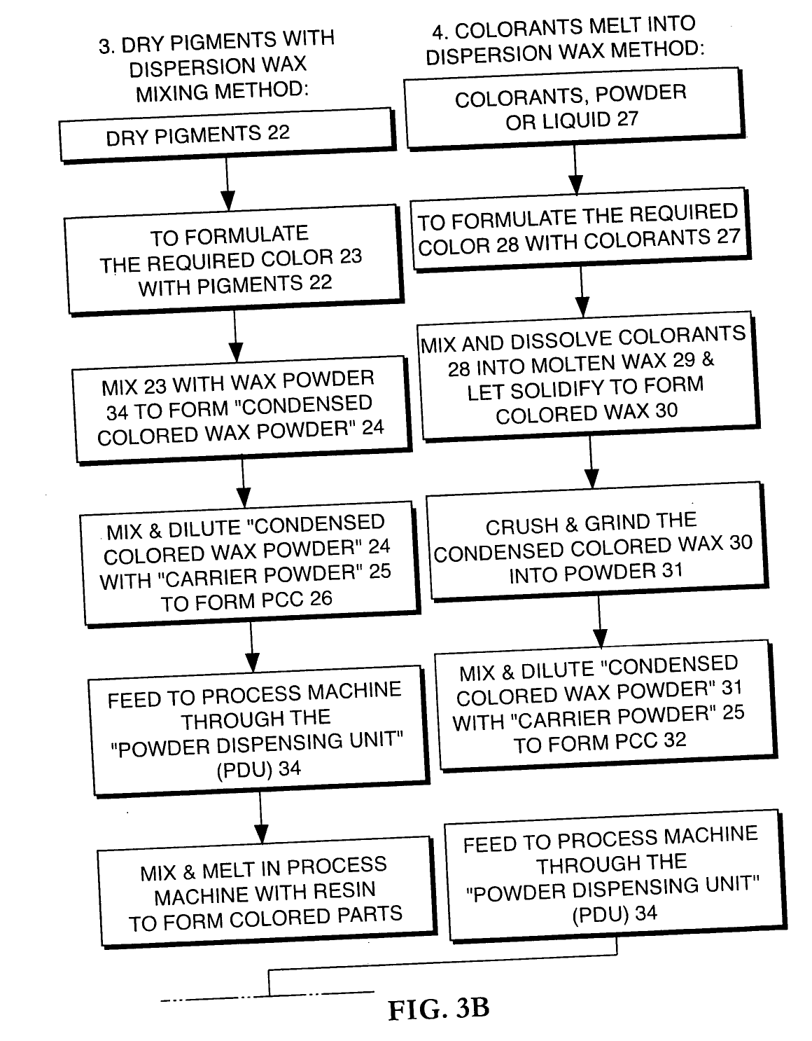

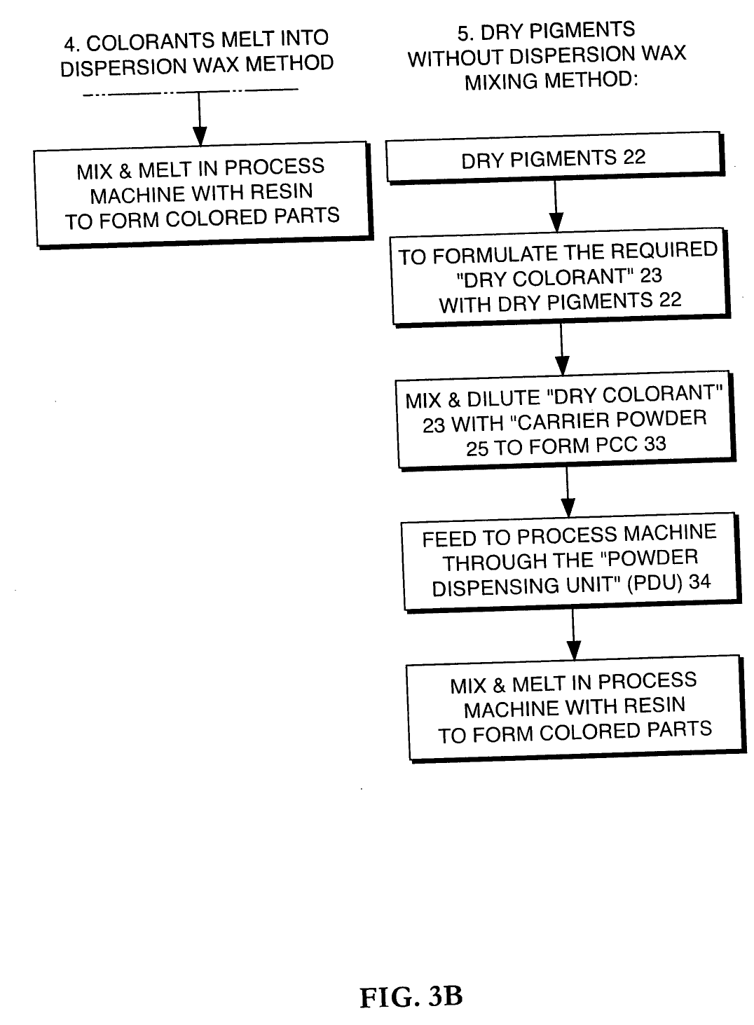

“Pigment dispersion agents” (or “dispersion agents”) are additives that help to disperse the pigment throughout a plastic during a melting and mixing process. Pigment dispersion agents include, but are not limited to, low melting point plastic waxes such as polyethylene wax. In one embodiment of processes and systems of the invention, pigment dispersion agents are used in accordance with PCC process 3 of FIG. 3B. In one embodiment of processes and systems of the invention where a pigment dispersion agent is not needed, a dry pigment colorant can be diluted with a “carrier powder” (defined hereinafter) in accordance with PCC process 5 of FIG. 3B.

“Plastic wax” in powder form (“plastic wax powder”) such as polyethylene wax produced by Marcus Oils and Chemicals Company (Houston, Tex.) is a commonly used dispersion agent. Plastic waxes are illustrated by compositions comprising a thermoplastic polymer, e.g., a polyolefin, and a dispersant such as a wax. In one embodiment of processes and systems of the invention, a plastic wax may be used as a dispersion agent in accordance with PCC processes 3 and 4 of FIG. 3B.

“Carrier powders” are made from ground carrier resins and are used as a pigment carrier. Carrier powders dilute and expand the volumetric characteristic of PCC systems of the invention and enable these systems to be dispensed accurately on per shot basis into a processing machine.

A “carrier resin” is a plastic resin which, by itself or in combination with one or more other compatible plastic resins, is processed to make a colored article. “Carrier resins” include but are not limited to the following plastic resins: amorphous, crystalline, or semi-crystalline thermoplastics, a thermoset, or a combination comprising at least one of the foregoing plastics. Some possible carrier resins include polyetherimides, polyetheretherketones, polyimides, polyvinyl chloride, polyolefins (including, but not limited to, linear and cyclic polyolefins and including polyethylene, chlorinated polyethylene, polypropylene, and the like), polyesters (including, but not limited to, polyethylene terephthalate, polybutylene terephthalate, polycyclohexylmethylene terephthalate, and the like), polyamides, polysulfones (including, but not limited to, polyethersulfones, polyetherethersulfones, hydrogenated polysulfones, and the like), polyimides, polyether imides, polyether sulfones, polyphenylene sulfides, polyether ketones, polyether ether ketones, ABS resins, polystyrenes (including, but not limited to, hydrogenated polystyrenes, syndiotactic and atactic polystyrenes, polycyclohexyl ethylene, styrene-co-acrylonitrile, styrene-co-maleic anhydride, and the like), polybutadiene, polyacrylates (including, but not limited to, polymethylmethacrylate, methyl methacrylate-polyimide copolymers, and the like), polyacrylonitrile, polyacetals, polycarbonates, polyphenylene ethers (including, but not limited to, those derived from 2,6-dimethylphenol and copolymers with 2,3,6-trimethylphenol, and the like), ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, tetrafluoroethylene fluorocarbon copolymers (e.g., Teflons), epoxy, phenolic, alkyds, polyester, polyimide, polyurethane, polysiloxanes, polysilanes, bis-maleimides, cyanate esters, vinyl, and benzocyclobutene resins, in addition to blends, copolymers, mixtures, reaction products and composites comprising at least one of the foregoing plastics.

A non-limiting list of preferred carrier resins includes polyethylene, polyvinyl chloride, polyolefins, polyesters, polyamides, polysulfones, polyether imides, polyether sulfones, polyphenylene sulfides, polyether ketones, polyether ether ketones, ABS resins, polystyrenes and polystyrene copolymers, polybutadiene, polyacrylates and polyacrylate copolymers, polyacrylnitrile, polyacetals, polycarbonates, polyphenylene ethers, ethylene-vinyl acetate copolymers, polyvinyl acetate, liquid crystal polymers, ethylene-tetrafluoroethylene copolymer, aromatic polyesters, polyvinyl fluoride. polyvinylidene fluoride, polyvinylidene chloride, teflons, and blends, copolymers, mixtures and composites thereof. Preferred resins include polycarbonates, and polyestercarbonates.

Particularly preferred carrier resins include either the following resin combinations or a single resin selected from one of the following resin combinations: (1) acrlyonitrile butadiene styrene (ABS), polyethylene (PE), polyvinylchloride (PVC), thermoplastic elastomer (TPE), and tetraphenylbutadiene (TPB); (2) PVC and ABS; (3) polycarbonates (PC) and ABS; (4) high-impact polystyrene (HIPS) and ABS; (5) TPE and ABS; (6) TPB, TPE, and ABS; (7) polypropylene (PP) and PE; and (8) ethylene-vinyl acetate copolymer (EVA) and PE.

“Dry pigment colorants” are preferably selected so that they mix readily with a plastic wax powder or molten plastic wax. “Liquid colorants” are also preferably selected so that they disperse readily in a molten plastic wax to form a “condensed colored plastic wax” (defined hereinafter).

Dry pigment colorants include dyes (e.g., “solvent dyes”), organic colorants, pigments, and the like, which behave like dyes; i.e., colorants that disperse in the plastic and do not form aggregates having a size greater than or equal to about 200 nm, with an aggregate size less than or equal to about 50 nm preferred. Dry pigment colorants and liquid colorants include, but are not limited to, those of the chemical family of anthraquinones, perylenes, perinones, indanthrones, quinacridones, xanthenes, oxazines, oxazolines, thioxanthenes, indigoids, thioindigoids, naphtalimides, cyanines, xanthenes, methines, lactones, coumarins, bis-benzoxaxolylthiophenes (BBOT), napthalenetetracarboxylic derivatives, monoazo and disazo pigments, triarylmethanes, aminoketones, bis(styryl)biphenyl derivatives, and the like, as well as combinations comprising at least one of the foregoing colorants.

The dry pigment colorants preferably have a finer particle size than the carrier powder so that they disperse well within the carrier powder. The dry pigment colorants preferably have a particle size of from about 0.01 microns to about 20 microns, usually about 0.5 microns to about 10 microns, and most preferably from about 0.03 microns to about 6 microns. In a preferred embodiment of PCC option (1) below, the dry pigment colorant and dispersion agent such as plastic wax powder are mixed and diluted in a conventional mixing device such as a ribbon blender, tumbler, shaker and power mixer in a weight ratio of from about 1 to about 400% of dry pigment colorant per unit weight of dispersion agent such as a wax powder.

A wide variety of “micro-bead color concentrates” and “basic color concentrate pellets” are commercially available and are well known to those of ordinary skill in the art. For example, PET micro-bead color concentrates can be made by dispersing pigment into a polymer and forming the polymer into beads that in some cases range in size from around 1.5-2.0 millimeters.

A “condensed colored plastic wax” and “condensed colored plastic wax powder” may be formed by mixing or dissolving dry pigment colorants or liquid colorants into a molten plastic wax; (2) solidifying the colored plastic wax mixture to form a condensed colored plastic wax; and (3) crushing and grinding the condensed colored wax to form a condensed colored wax powder.

The embodiments illustrated hereinafter are illustrative and are in no way limiting.

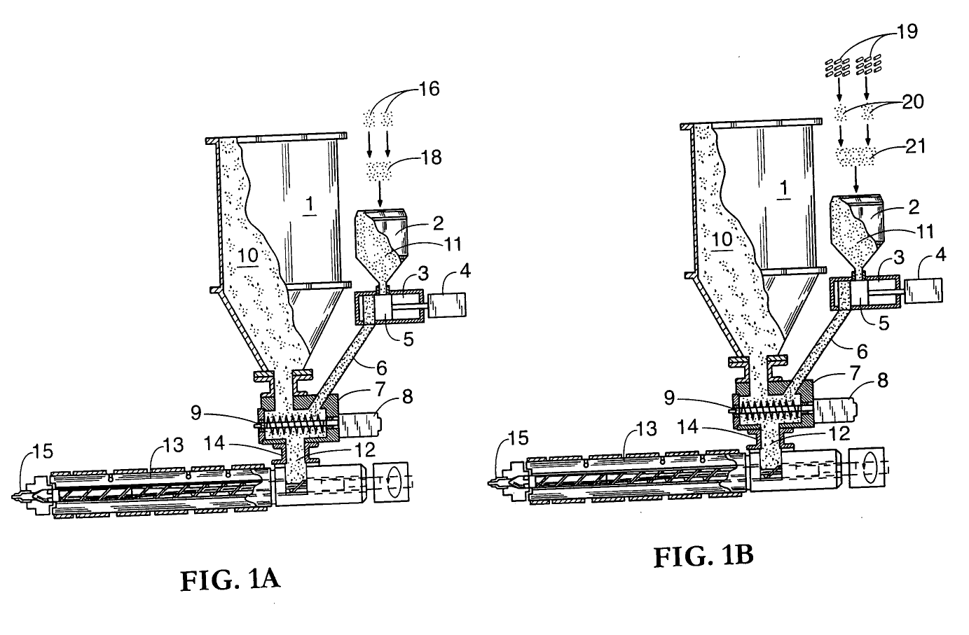

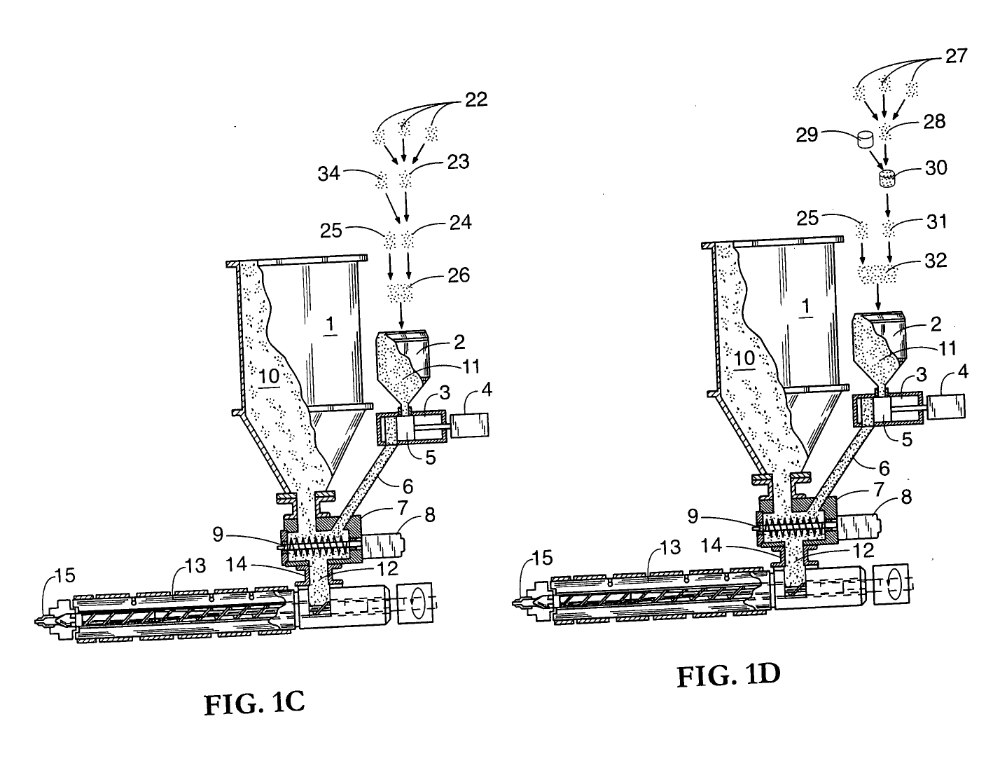

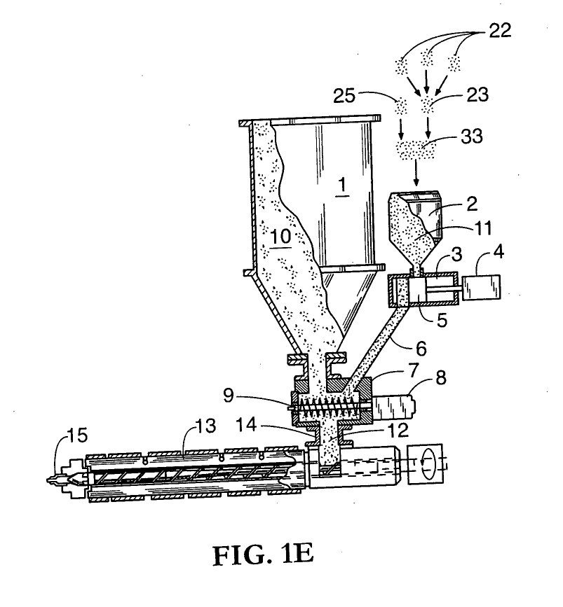

In one embodiment of the invention, MCCM systems are made by mixing at least two basic color micro-sized concentrate powders formed:
(1) as shown in FIG. 1A and process 1 of FIG. 3A, by mixing in a ratio which provides a desired color two or more basic color micro-bead color concentrates 16 to form MCCM 18 (hereinafter “MCCM option (1)”); or
(2) as shown in FIG. 1B and process 2 of FIG. 3A, by grinding basic color concentrate pellets 19 into powder form 20 with particle size of from about 25 to about 1,000 microns, preferably about 80 to about 500 microns, and most preferably about 100 to about 300 microns to form MCCM 21 (hereinafter “MCCM option (2)”).

In making a MCCM system in accordance with MCCM option (1), basic color micro-bead color concentrates normally have a particle size of from about 25 to about 1,000 microns, usually about 80 to about 500 microns, and preferably from about 100 to about 300 microns.

Basic color micro-sized concentrate powders can be mixed in a conventional mixing device such as a ribbon blender, tumbler, shaker, or power mixer.

FIGS. 1C to 1E and FIG. 3B illustrate processes for making DPCDC's comprising a PCC system.

In the process of the invention illustrated in FIG. 1C and process 3 of FIG. 3B (hereinafter “PCC option (1)”): (1) a plastic wax powder 34 is mixed with dry pigment colorants 23 (formed by mixing dry pigments 22) to form a condensed colored plastic wax powder 24; (2) condensed colored plastic wax powder 24 is mixed and diluted with a carrier powder 25 formed by grinding a carrier resin to a particle size from about 25 to about 1,000 microns to form PCC 26.

In the process of the invention illustrated in FIG. 1D and process 4 of FIG. 3B (hereinafter “PCC option (2)”), a colored plastic wax mixture is formed by: (1) mixing or dissolving dry pigment colorants or liquid colorants 27 to desired color blend 28; (2) mixing or dissolving blend 28 into a molten plastic wax 29 to form a colored plastic wax mixture; (3) solidifying the colored plastic wax mixture to form a condensed colored plastic wax 30; (3) crushing and grinding the condensed colored plastic wax to form a condensed colored wax powder 31; and (4) mixing and diluting the condensed colored plastic wax powder with a carrier powder 25 formed by grinding a carrier resin to a particle size from about 25 to about 1,000 microns to form PCC 32.

In the process of the invention illustrated in FIG. 1E and process 5 of FIG. 3B (hereinafter “PCC option (3)”), dry pigment colorants 23 (formed by mixing dry pigments 22) are mixed and diluted with a carrier powder 25 formed by grinding a carrier resin to a particle size from about 25 to about 1,000 microns to form PCC 33.

The condensed colored plastic wax powder and carrier powder (PCC option (1)), condensed colored plastic wax powder and carrier powder (PCC option (2)), or dry pigment colorants and carrier powder (PCC option (3)) can be mixed in a conventional mixing device such as a ribbon blender, tumbler, shaker and power mixer.

The dry pigment colorants used in PCC options (1)-(3) may be a powdered form of pigments and dyes. The plastic wax powder of PCC option (1), or molten plastic wax of PCC option (2), may be a plastic wax (e.g., a polyethylene (“PE”) wax).

In PCC option (2), dry pigment colorants or liquid colorants can be mixed and dissolved into a molten plastic wax in a reaction vessel such as a plastic wax melting pot mixer, at a temperature of from about 70° C. to about 150° C. and for a reaction time of between about 5 seconds to about 15 minutes. Thereafter, the solidified colored plastic wax is ground into a powder form having a particle size from about 25 to about 1,000 microns.

In one embodiment, the invention provides processes for making colored thermoplastic articles comprising mixing and melting a DPCDC of the invention and a plastic resin in a mixing and melting barrel unit, wherein the carrier powder and plastic resin each comprise one or more plastics selected from the groups consisting of: (1) ABS, PE, PVC, TPE, and TPB; (2) PVC and ABS; (3) PC and ABS; (4) HIPS and ABS; (5) TPE and ABS; (6) TPB, TPE, and ABS; (7) PP and PE; and (8) EVA and PE.

In preferred embodiments of PCC options (1) and (2), the condensed colored plastic wax powder is made by either PCC option 1 or PCC option 2, which are described hereinafter.

(A) PCC option (1): entails mixing at least one dry colorant (i.e., a powdered form of pigments and dyes) with a known dispersion agent such as but not limit to polyethylene wax powder in powder form with a particle size similar to that of the carrier (i.e., from about 25 to about 1,000 microns, usually from about 80 to about 500 microns, and preferably from about 100 to about 300 microns).

The dry pigment colorants preferably have a finer particle size than the plastic wax powder so that it disperses better within the pigment plastic wax powder mixture. The dry pigment colorant preferably has a particle size (i.e., from about 0.01 microns to about 20 microns, usually about 0.5 microns to about 10 microns, and preferably from about 0.03 microns to about 6 microns). In a preferred embodiment of PCC option (1), the dry pigment colorant and dispersion agent such as plastic wax powder are mixed and diluted in a conventional mixing device such as a ribbon blender, tumbler, shaker and power mixer in a weight ratio of from about 1 to about 400% of dry pigment colorant per unit weight of dispersion agent such as a plastic wax powder.

(B) PCC option (2): entails mixing at least one colorant (i.e., a powdered form of pigments and dyes) into the molten plastic wax dispersion agent (e.g., a polyethylene (“PE”) wax) in a reaction vessel including but not limited to a plastic wax melting pot mixer, at a temperature of from about 70° C. to about 150° C., usually about 90° C. to about 130° C., and preferably from about 110° C. to 120° C., and for a reaction time of between about 5 seconds to about 15 minutes, usually about 10 seconds to about 2 minutes, and preferably from about 15 seconds to 30 seconds, and thereafter grinding the solidified “colored wax” in an industrial grinder into powder form having a similar particle size as that of the carrier (i.e., from about 25 to about 1,000 microns, usually about 80 to about 500 microns, and preferably from about 100 to about 300 microns).

In a preferred embodiment of PCC option (2), the weight ratio of colorant to plastic wax is from about 1 to about 400% of colorants per unit weight of dispersion agent such as wax powder.

The condensed colored plastic wax powder to carrier powder weight ratio in PCC options (1) and (2) usually ranges from about 0.1% to about 50%, normally from about 5% to about 20%, and preferably from about 10% to about 15% condensed colored plastic wax powder per unit weight of carrier powder.

In a preferred embodiment of PCC option (3), the dry pigment colorant and carrier powder are mixed and diluted in a conventional mixing device such as a ribbon blender, tumbler, shaker and power mixer in a weight ratio of from about 0.1 to about 40% of dry pigment colorant per unit weight of carrier powder. The dry pigment colorant preferably has a finer particle size than the carrier powder so that it disperses better within the pigment carrier powder mixture. The dry pigment colorant preferably has a particle size of from about 0.01 microns to about 20 microns, more preferably about 0.5 microns to about 10 microns, and most preferably from about 0.03 microns to about 6 microns).

Either the PCC or the MCCM is used as the DPCDC, is fed to the PDU, and thereafter is dispensed in a preset amount with plastic resin into a mixing and melting barrel, e.g., of an injection molding machine or blow molding machine. The DPCDC is dispensed and fed directly into a mixing and melting barrel unit together with the plastic resin. A dispenser controls the dispensing amount of DPCDC (i.e., the amounts of PCC or MCCM as determined by the DPCDC to shot weight ratio). The DPCDC to plastic resin weight ratio ranges by weight from about 1% to about 15% of DPCDC per unit weight of plastic resin, preferably from about 2% to about 8%, and most preferably from about 3% to about 5%.

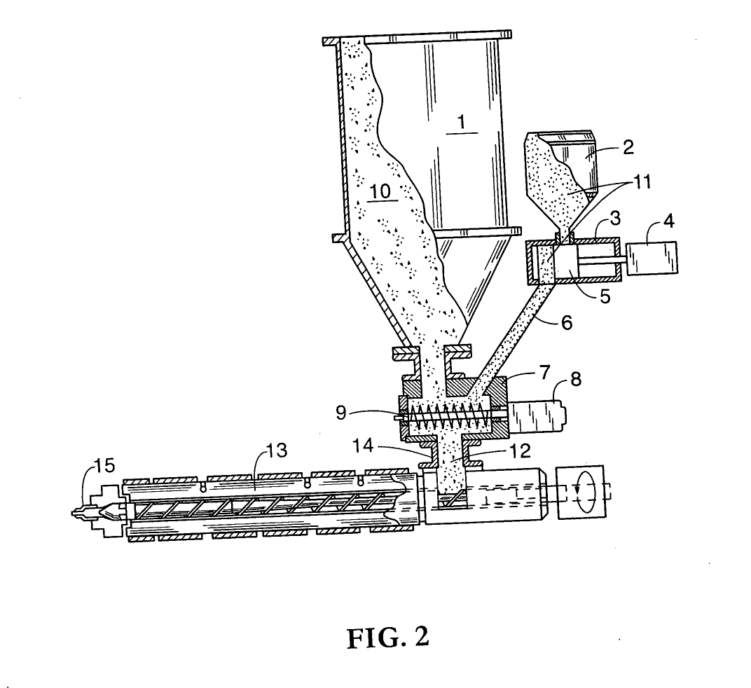

In the process and apparatus illustrated in FIG. 2, a DPCDC 11 is gravity fed through a PDU 34 into a driving mechanism which feeds the DPCDC 11 into a mixing and melting barrel into which plastic resin pellets 10 are gravity fed in parallel. The PDU comprises powder container 2, which contain the PCC or MCCM DPCDC 11. The outlet of container 2 connects to the volumetric metering unit 3 which consists of a volume adjustable powder transfer member 5 and a driving mechanism 4, the amount of DPCDC powder will be adjusted by the cavity volume of the transfer member 5. The outlet of the volumetric metering unit links to a feeding tube 6, which feeds into a resin pellet and DPCDC mixing unit 7 consisting of a mixing device such as a mixing screw 9 and driving mechanism 8 such as a geared motor. Resin pellets hopper 1 stores resin pellets 10 and the outlet of hopper 1 is connected to an inlet of mixing unit 7. Resin pellets 10 are gravity fed to an intake of mixing unit 7. The outlet of mixing unit 7 is linked to inlet 14 of a mixing and melting barrel 13 of a plastic resin processing machine.

The main body and components of the PDU can be made from a variety of known materials which have good rigidity and corrosion resistance, such as metals, ceramics, and plastics. Metals such as stainless steel alloys and aluminum alloys are preferred.

Volume adjustable powder transfer member 5 transfers a pre-set amount of DPCDC 11 from an inlet to an outlet of volumetric metering unit 3, which is gravity fed to the intake of the resin pellet and DPCDC mixing unit 7. The pre-set amount is proportional to the resin pellet process rate (such as shot weight in injection molding process) and need to be changes if process rate, resin or color changes. The resin pellet and DPCDC mixture 12 is then gravity fed to the intake 14 of the mixing and melting barrel unit 13. The transfer member 5 can be made from a variety of known materials having good rigidity and corrosion resistance such as metal, ceramics, and plastics; metals such as stainless steel alloys and aluminum alloys are preferred.

In one embodiment, driving mechanism 4 is synchronized with a plastic resin processing machine to drive a powder transfer member that reciprocates linearly or rotationally between the inlet and the outlet of volumetric metering unit 3 and delivers a preset amount of powder to the plastic resin processing machine. The driving mechanism 4 can be powered by a variety of known mechanical techniques such as pneumatic, electro-mechanical, hydraulic, and shape memory alloy techniques.

Resin pellet and DPCDC mixing unit 7 can be made from a variety of known materials which have good rigidity and corrosion resistance, such as metals, ceramics, and plastics. Metals such as stainless steel alloys and aluminum alloys are preferred. In preferred embodiments, the rotational speed of mixing screw 9 can range from about 30 to about 600 revolutions per minute (rpm) to avoid over-heating the resin and colorants. Driving mechanism 8 can be powered by a variety of known mechanical techniques such as pneumatic, electromechanical, hydraulic techniques.

1. A DPCDC comprising a PCC system made by either:
(1) mixing a plastic wax powder with a dry pigment colorant to form a condensed colored plastic wax powder; and mixing and diluting the condensed colored plastic wax powder with a carrier powder formed by grinding a carrier resin to a particle size from about 25 to about 1,000 microns; or
(2) forming a colored plastic wax mixture by mixing or dissolving a dry pigment colorant or liquid colorant into a molten plastic wax; solidifying the colored plastic wax mixture to form a condensed colored plastic wax; crushing and grinding the condensed colored plastic wax to form a condensed colored plastic wax powder; and mixing and diluting the condensed colored plastic wax powder with a carrier powder formed by grinding a carrier resin to a particle size from about 25 to about 1,000 microns; or
(3) mixing and diluting a dry pigment colorant and a carrier powder formed by grinding a carrier resin to a particle size from about 25 to about 1,000 microns.

2. A DPCDC of claim 1, wherein the PCC system is made by:
(a) mixing or dissolving dry pigment colorants or liquid colorants into a molten plastic wax in a reaction vessel at a temperature of from about 70° C. to about 150° C. and for a reaction time of between about 5 seconds to about 15 minutes to form a condensed colored plastic wax;
(b) crushing and grinding the condensed colored plastic wax to form a condensed colored plastic wax powder; and
(c) mixing and diluting the condensed colored plastic wax powder with a carrier powder formed by grinding a carrier resin to a particle size from about 25 to about 1,000 microns.

3. A DPCDC of claim 1, wherein the PCC system is made by mixing at least one dry colorant comprising a powdered form of a pigment or dye with a plastic wax in powder form, wherein the dry colorant and plastic wax have a particle size of from about 25 to about 1,000 microns.

4. A DPCDC of claim 3, wherein the dry colorant and plastic wax have a particle size of from about 80 to about 500 microns.

5. A DPCDC of claim 3, wherein the dry colorant and plastic wax have a particle size of from about 100 to about 300 particles per square inch.

6. A DPCDC of claim 2, wherein the PCC system is made by:
(a) mixing or dissolving dry pigment colorants or liquid colorants into a molten plastic wax in a reaction vessel at a temperature of from about 90° C. to about 130° C. and for between about 10 seconds to about 2 minutes to form a condensed colored plastic wax;
(b) crushing and grinding the condensed colored plastic wax to form a condensed colored plastic wax powder having a substantially similar particle size of from about 25 to about 1,000 microns; and
(c) mixing and diluting the condensed colored plastic wax powder with a carrier powder formed by grinding a carrier resin to a particle size of from about 25 to about 1,000 microns.

7. A DPCDC of claim 2, wherein the PCC system is made by:
(a) mixing or dissolving dry pigment colorants or liquid colorants into a molten plastic wax in a reaction vessel at a temperature of from about 110° C. to 120° C. and for between about 15 seconds to about 30 seconds to form a condensed colored plastic wax;
(b) crushing and grinding the condensed colored plastic wax to form a condensed colored plastic wax powder having a similar particle size of from about 80 to about 500 microns; and
(c) mixing and diluting the condensed colored plastic wax powder with a carrier powder formed by grinding a carrier resin to a particle mesh size from about 80 to about 500 microns.

8. A DPCDC of claim 2, wherein the PCC system is made by:
mixing or dissolving dry pigment colorants or liquid colorants into a molten plastic wax in a reaction vessel at a temperature of from about 110° C. to about 120° C. and for between about 15 seconds to about 30 seconds to form a condensed colored plastic wax;
crushing and grinding the condensed colored plastic wax to form a condensed colored plastic wax powder having a particle size of from about 100 to about 300 microns; and
mixing and diluting the condensed colored plastic wax powder with a carrier powder formed by grinding a carrier resin to a particle size from about 100 to about 300 microns.

9. A DPCDC of claim 2, wherein the condensed colored plastic wax powder to carrier powder weight ratio ranges from 0.1% to about 50% condensed colored plastic wax powder per unit weight of carrier powder.

10. A DPCDC of claim 2, wherein the condensed colored plastic wax powder to carrier powder weight ratio ranges from about 10% to about 15% condensed colored plastic wax powder per unit weight of carrier powder.

11. A DPCDC of claim 3, wherein the condensed colored plastic wax powder to carrier powder weight ratio ranges from 0.1% to about 50% condensed plastic colored wax powder per unit weight of carrier powder.

12. A DPCDC of claim 3, wherein the condensed colored plastic wax powder to carrier powder weight ratio ranges from about 10% to about 15% condensed colored wax powder per unit weight of carrier powder.

13. A DPCDC comprising a MCCM system made either by:
(1) mixing two or more basic color micro-bead color concentrates; or
(2) grinding basic color concentrate pellets into powder form with particle size of from about 25 to about 1,000 microns.

14. A DPCDC of claim 13, wherein the MCCM system is made by grinding basic color concentrate pellets into powder form with particle size of from about 80 to about 500 microns.

15. A DPCDC of claim 13, wherein the MCCM system is made by grinding basic color concentrate pellets into powder form with particle size of from about 100 to about 300 microns.

16. A process for making colored thermoplastic articles comprising mixing and melting a DPCDC of claim 1 and a plastic resin in a mixing and melting barrel unit, wherein the weight ratio of DPCDC to plastic resin ranges from 1% to about 15% of DPCDC per unit weight of plastic resin.

17. A process for making colored thermoplastic articles comprising mixing and melting a DPCDC of claim 1 and a plastic resin in a mixing and melting barrel unit, wherein the weight ratio of DPCDC to plastic resin ranges from 2% to about 8%, of DPCDC per unit weight of plastic resin.

18. A process for making colored thermoplastic articles comprising mixing and melting a DPCDC of claim 1 and a plastic resin in a mixing and melting barrel unit, wherein the weight ratio of DPCDC to plastic resin ranges from 3% to about 5% of DPCDC per unit weight of plastic resin.

19. A process for making colored thermoplastic articles comprising mixing and melting a DPCDC of claim 13 and a plastic resin in a mixing and melting barrel unit, wherein the weight ratio of DPCDC to plastic resin ranges from 1% to about 15% of DPCDC per unit weight of plastic resin.

20. A process for making colored thermoplastic articles comprising mixing and melting a DPCDC of claim 13 and a plastic resin in a mixing and melting barrel unit, wherein the weight ratio of DPCDC to plastic resin ranges from 2% to about 8%, of DPCDC per unit weight of plastic resin.

21. A process for making colored thermoplastic articles comprising mixing and melting a DPCDC of claim 13 and a plastic resin in a mixing and melting barrel unit, wherein the weight ratio of DPCDC to plastic resin ranges from 3% to about 5% of DPCDC per unit weight of plastic resin.

22. A process for making colored thermoplastic articles comprising mixing and melting a DPCDC of claim 2 and a plastic resin in a mixing and melting barrel unit, wherein:
(c) the weight ratio of DPCDC to plastic resin ranges from 1% to about 15% of DPCDC per unit weight of plastic resin; and
(d) the carrier powder and plastic resin are comprised of either the same plastic or two or more different plastics.

23. A process of claim 22, wherein the carrier powder and plastic resin each comprise one or more plastics selected from the groups consisting of: (1) ABS, PE, PVC, TPE, and TPB; (2) PVC and ABS; (3) PC and ABS; (4) HIPS and ABS; (5) TPE and ABS; (6) TPB, TPE, and ABS; (7) PP and PE; and (8) EVA and PE.

24. A colored thermoplastic article made by a process comprising mixing and melting a DPCDC of claim 1 and a plastic resin in a mixing and melting barrel unit, wherein the weight ratio of DPCDC to plastic resin ranges from 1% to about 15% of DPCDC per unit weight of plastic resin.

25. A colored thermoplastic article made by an injection molding process comprising mixing and melting a DPCDC of claim 1 and a plastic resin in a mixing and melting barrel unit, wherein the weight ratio of DPCDC to plastic resin ranges from 1% to about 15% of DPCDC per unit weight of plastic resin.

26. A colored thermoplastic article made by a process comprising mixing and melting a DPCDC of claim 13 and a plastic resin in a mixing and melting barrel unit, wherein the weight ratio of DPCDC to plastic resin ranges from 1% to about 15% of DPCDC per unit weight of plastic resin.

27. A colored thermoplastic article made by an injection molding process comprising mixing and melting a DPCDC of claim 13 and a plastic resin in a mixing and melting barrel unit, wherein the weight ratio of DPCDC to plastic resin ranges from 1% to about 15% of DPCDC per unit weight of plastic resin.

28. A process for making a colored thermoplastic article comprising mixing and melting a DPCDC of claim 1 and a plastic resin in a mixing and melting barrel unit, wherein the weight ratio of DPCDC to plastic resin ranges from 1% to about 15% of DPCDC per unit weight of plastic resin.

29. A process for making a colored thermoplastic article comprising mixing and melting a DPCDC of claim 13 and a plastic resin in a mixing and melting barrel unit, wherein the weight ratio of DPCDC to plastic resin ranges from 1% to about 15% of DPCDC per unit weight of plastic resin.

30. A process of claim 29, wherein the process is an injection molding process.

31. A process for making a colored thermoplastic article comprising mixing and melting a DPCDC and a plastic resin pellets in a mixing and melting barrel unit, wherein the weight ratio of DPCDC to plastic resin ranges from 1% to about 15% of DPCDC per unit weight of plastic resin, and wherein the DPCDC is made by either
(1) mixing a plastic wax powder with dry pigment colorants to form a condensed colored plastic wax powder; and thereafter mixing and diluting the condensed colored plastic wax powder with a carrier powder formed by grinding a carrier resin to a particle size from about 25 to about 1,000 microns; or
(2) forming a colored plastic wax mixture by mixing or dissolving dry pigment colorants or liquid colorants into a molten plastic wax; solidifying the colored wax mixture to form a condensed colored plastic wax; crushing and grinding the condensed colored plastic wax to form a condensed colored wax powder; and mixing and diluting the condensed colored plastic wax powder with a carrier powder formed by grinding a carrier resin to a particle size of from about 1000 to about 25 microns;
(3) mixing and diluting dry pigment colorants and a carrier powder formed by grinding a carrier resin to a particle size of from about 1000 to about 25 microns;
(4) mixing two or more basic color micro-bead color concentrates; or
(5) grinding basic color concentrate pellets into powder form with particle size of from about 25 to about 1,000 microns, and wherein
the DPCDC is gravity fed through a PDU into a driving mechanism that feeds the DPCDC into the mixing and melting barrel into which the plastic resin pellets are gravity fed in parallel.

32. A DPCDC of claim 1, wherein the DPCDC is made by a process comprising mixing at least one dry colorant with a known dispersion agent in powder form with a particle size substantially similar to that of the carrier.

33. A DPCDC of claim 32, wherein the dry colorant has a particle size which is finer than that of the condensed colored plastic wax powder.

34. A DPCDC of claim 32, wherein the dry colorant has a particle size of from about 0.01 microns to about 20 microns.

35. A DPCDC of claim 32, wherein the dry colorant and dispersion agent are mixed and diluted in a weight ratio of from about 1 to about 400% of dry colorant per unit weight of dispersion agent.

36. A process for making colored thermoplastic articles comprising mixing and melting a DPCDC of claim 3 and a plastic resin in a mixing and melting barrel unit, wherein:
(a) the weight ratio of DPCDC to plastic resin ranges from 1% to about 15% of DPCDC per unit weight of plastic resin; and
(b) the carrier powder and plastic resin are comprised of either the same plastic or two or more different plastics.

37. A process of claim 37, wherein the carrier powder and plastic resin each comprise one or more plastics selected from the groups consisting of: (1) ABS, PE, PVC, TPE, and TPB; (2) PVC and ABS; (3) PC and ABS; (4) HIPS and ABS; (5) TPE and ABS; (6) TPB, TPE, and ABS; (7) PP and PE; and (8) EVA and PE.
